(19) United States
(12) Patent Application Publication
(10) Pub. No.: US 2022/0171388 A1
(43) Pub. Date: Jun. 2, 2022

(54) TRANSPORTATION SYSTEM, TRANSPORTATION METHOD, AND TRANSPORTATION PROGRAM

(71) Applicant: TOYOTA JIDOSHA KABUSHIKI KAISHA, Toyota-shi Aichi-ken (JP)

(72) Inventors: Takaaki Yanagihashi, Toyota-shi (JP); Takahiro Okano, Chiryu-shi (JP); Toru Takashima, Susono-shi (JP); Hiroaki Kiyokami, Nisshin-shi (JP); Kenta Miyahara, Okazaki-shi (JP); Yohei Tanigawa, Toyota-shi (JP)

(73) Assignee: TOYOTA JIDOSHA KABUSHIKI KAISHA, Toyota-shi Aichi-ken (JP)

(21) Appl. No.: 17/487,289

(22) Filed: Sep. 28, 2021

(30) Foreign Application Priority Data
Nov. 30, 2020 (JP) 2020-198437

(51) Int. Cl. G05D 1/00; B65D 19/42; B65G 43/00; B65G 1/137; G06Q 10/08

(52) U.S. Cl. CPC G05D 1/0088; B65D 19/42; B65G 43/00; B62D 51/001; G06Q 10/083; B65D 2519/00781; B65G 1/1373

(57) ABSTRACT

A transportation system is equipped with at least one self-propelled pallet that can move and that is loaded with a piece of luggage, a vehicle that accommodates the at least one self-propelled pallet, and an administrative server that commands the self-propelled pallet loaded with the piece of luggage to move to a place of reception of the piece of luggage, and that commands the self-propelled pallet loaded with no luggage to move to the vehicle after the piece of luggage is unloaded at the place of reception.

### CROSS-REFERENCE TO RELATED APPLICATION

This application claims priority to Japanese Patent Application No. 2020-198437 filed on Nov. 30, 2020, incorporated herein by reference in its entirety.

### BACKGROUND

### 1. Technical Field

The present disclosure relates to a transportation system, a transportation method, and a transportation program for transporting pieces of luggage through the use of a transporter that can be accommodated in a vehicle.

### 2. Description of Related Art

In Japanese Unexamined Patent Application Publication No. 2018-205806 (JP 2018-205806 A), there is disclosed a transportation plan generation system that provisionally sets a mobile warehouse that can be temporarily installed and that can move in the case where there are a plurality of shipping origins, that changes a delivery route such that goods are delivered to shipping addresses via the mobile warehouse, and that generates a command to move for delivery means and the mobile warehouse so as to realize the changed delivery route.

### SUMMARY

In the transportation plan generation system of Japanese Unexamined Patent Application Publication No. 2018-205806 (JP 2018-205806 A), it is difficult in some cases to set a place where there are restrictions on a parking space for delivery vehicles or unloading facilities such as a crane, as the mobile warehouse. In particular, at the place of arrival of vehicles that is the mobile warehouse, a plurality of vehicles gather, so the time for unloading pieces of luggage is lost. It is costly to additionally provide unloading facilities. Besides, in order to convey a piece of luggage from a place of arrival of a vehicle to a place of reception, the piece of luggage needs to be conveyed after being reloaded into another vehicle.

It is an object of the present disclosure to provide a transportation system, a transportation method, and a transportation program that, in conveying a piece of luggage from a place of arrival of a vehicle to a place of reception, enable the operation of reloading the piece of luggage into another vehicle to be omitted.

A transportation system according to a first aspect is equipped with at least one transporter that can move and that is loaded with a piece of luggage, a vehicle that accommodates the at least one transporter, and a command unit that commands the transporter loaded with the piece of luggage to move to a place of reception of the piece of luggage, and that commands the transporter loaded with another piece of luggage or the transporter loaded with no luggage to move to the vehicle after the piece of luggage is unloaded at the place of reception.

The transportation system according to the first aspect is equipped with the at least one transporter, the vehicle, and the command unit. The transporter is configured to be movable and accommodatable in the vehicle. In the transportation system, the command unit commands the transporter loaded with the piece of luggage to move from a place of arrival of the vehicle to the place of reception of the piece of luggage. Besides, after the piece of luggage is unloaded at the place of reception, the command unit commands the transporter loaded with another piece of luggage or the transporter loaded with no luggage to move to the vehicle. Accordingly, with this transportation system, the operation of reloading the piece of luggage into another vehicle can be omitted in conveying the piece of luggage from the place of arrival of the vehicle to the place of reception of the piece of luggage.

A transportation system according to a second aspect is obtained by modifying the transportation system according to the first aspect as follows. The transporter is equipped with an environment sensor that collects environmental information around the transporter, a drive unit to which a running wheel is connected, and an autonomous control unit that controls the drive unit based on the collected environmental information and that causes the transporter to autonomously run to the place of reception.

The transportation system according to the second aspect is characterized in that the transporter runs autonomously. Therefore, the transportation system does not need any tow vehicle or the like for moving the transporter.

A transportation system according to a third aspect is obtained by modifying the transportation system according to the second aspect as follows. The environment sensor collects an identification tag attached to the piece of luggage with which the transporter is loaded, as identification information, and the autonomous control unit causes the transporter to run to the place of reception of the piece of luggage to which the identification tag is attached, based on the collected identification information.

In the transportation system according to the third aspect, the autonomous control unit causes the transporter to run to the place of reception based on the collected identification information regarding the identification tag. With the transportation system, the process of redesignating the place of reception is made unnecessary even in the case where reloading of the piece of luggage or the like occurs in the vehicle, by associating the information on the place of reception with the identification tag.

A transportation system according to a fourth aspect is obtained by modifying the transportation system according to the second aspect or the third aspect as follows. The transporter is equipped with a measurement unit that measures a weight of the piece of luggage with which the transporter is loaded, and the autonomous control unit causes the transporter to run to the place of reception as one of a plurality of such places of reception, based on the weight measured by the measurement unit.

With the transportation system according to the fourth aspect, in the case where there are a plurality of places of reception of the same piece of luggage, the efficiency of transportation from the place of arrival of the vehicle onward can be enhanced by selecting the place of reception based on the weight measured by the measurement unit.

A transportation system according to a fifth aspect is obtained by modifying the transportation system according to any one of the first to fourth aspects as follows. The transportation system includes a plurality of standardized transporters identical to the transporter.

With the transportation system according to the fifth aspect, no trouble is caused even when another transporter is accommodated in the vehicle without waiting for the transporter that has transported the piece of luggage to return, by standardizing the transporters. Therefore, with the transportation system, the waiting time until the return of the transporter transporting the piece of luggage to the vehicle can be eliminated, so the efficiency in transporting the piece of luggage can be further enhanced.

A transportation system according to a sixth aspect is obtained by modifying the transportation system according to any one of the first to fifth aspects as follows. The transporter is equipped with a battery for driving the vehicle, and the command unit commands the transporter with the charged battery to move to the vehicle.

The transportation system according to the sixth aspect is applied to the vehicle that is driven by the battery. With this transportation system, the parking time resulting from charging can be made shorter than in the case where the vehicle is equipped with a battery, by accommodating the transporter mounted in advance with the charged battery in the vehicle.

A transportation method according to a seventh aspect is for use in a transportation system equipped with at least one transporter that can move and that is loaded with a piece of luggage, and a vehicle that accommodates the at least one transporter. In this method, a computer performs a process of commanding the transporter loaded with the piece of luggage to move to a place of reception of the piece of luggage, and commanding the transporter loaded with another piece of luggage or the transporter loaded with no luggage to move to the vehicle after the piece of luggage is unloaded at the place of reception.

The transportation method according to the seventh aspect is applied to the transportation system equipped with the at least one transporter and the vehicle. In this transportation method, the computer commands the transporter loaded with the piece of luggage to move from the place of arrival of the vehicle to the place of reception of the piece of luggage. Besides, after the piece of luggage is unloaded at the place of reception, the computer commands the transporter loaded with another piece of luggage or the transporter loaded with no luggage to move to the vehicle. Accordingly, with this transportation method, the operation of reloading the piece of luggage into another vehicle can be omitted in conveying the piece of luggage from the place of arrival of the vehicle to the place of reception.

A transportation program according to an eighth aspect is executed in a transportation system equipped with at least one transporter that can move and that is loaded with a piece of luggage, and a vehicle that accommodates the at least one transporter. The transportation program is designed to cause a computer to perform a process of commanding the transporter loaded with the piece of luggage to move to a place of reception of the piece of luggage, and commanding the transporter loaded with another piece of luggage or the transporter loaded with no luggage to move to the vehicle after the piece of luggage is unloaded at the place of reception.

In the transportation program according to the eighth aspect, the computer performs the following process in the transportation system equipped with the at least one transporter and the vehicle. That is, the computer commands the transporter loaded with the piece of luggage to move from the place of arrival of the vehicle to the place of reception of the piece of luggage. Besides, after the piece of luggage is unloaded at the place of reception, the computer commands the transporter loaded with another piece of luggage or the transporter loaded with no luggage to move to the vehicle. Accordingly, with this transportation program, the operation of reloading the piece of luggage into another vehicle can be omitted in conveying the piece of luggage from the place of arrival of the vehicle to the place of reception.

According to the present disclosure, in the case where a piece of luggage is conveyed from a place of arrival of a vehicle to a place of reception, the operation of reloading the piece of luggage into another vehicle can be omitted.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view showing the schematic configuration of a transportation system according to the first embodiment;

FIG. 2 is a block diagram showing the hardware configuration of a vehicle of the first embodiment;

FIG. 3 is a view illustrating the structure of a self-propelled pallet of the first embodiment;

FIG. 4 is a block diagram showing the hardware configuration of the self-propelled pallet of the first embodiment;

FIG. 5 is a block diagram showing the functional configuration of the self-propelled pallet of the first embodiment;

FIG. 6 is a block diagram showing the hardware configuration of an administrative server of the first embodiment;

FIG. 7 is a view showing an example of information stored in a status DB in the administrative server of the first embodiment;

FIG. 8A is a flowchart showing an example of the flow of a guidance process that is performed by the administrative server of the first embodiment; and

FIG. 8B is a flowchart showing the example of the flow of the guidance process that is performed by the administrative server of the first embodiment (continued from FIG. 8A).

### DETAILED DESCRIPTION OF EMBODIMENTS

A transportation system of the present disclosure will be described using the drawings. The transportation system makes it possible to deliver luggage through the use of a delivery vehicle such as a truck, and a transporter that can be accommodated in the vehicle.

### First Embodiment

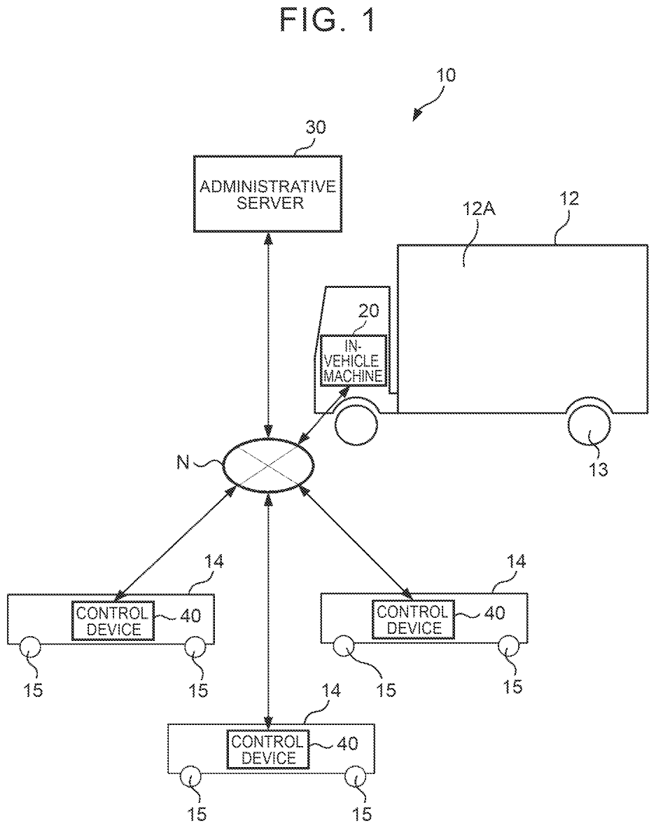

As shown in FIG. 1, a transportation system 10 of the first embodiment is configured to include a vehicle 12, a plurality of self-propelled pallets 14 as transporters, and an administrative server 30. The vehicle 12 is loaded with an in-vehicle machine 20. Besides, the self-propelled pallets 14 are loaded with control devices 40 respectively.

The in-vehicle machine 20, the control devices 40, and the administrative server 30 are connected to one another through a network N. Incidentally, the in-vehicle machine 20 or the control devices 40 and the administrative server 30 may be connected to each other through one network, whereas the in-vehicle machine 20 and the control devices 40 may be connected to each other through another network. Besides, in FIG. 1, the single in-vehicle machine 20 and the three control devices 40 are connected to the single administrative server 30. However, the number of in-vehicle machines 20 to be connected, the number of control devices 40 to be connected, and the number of administrative servers 30 to be connected are not limited in this manner.

### Vehicle

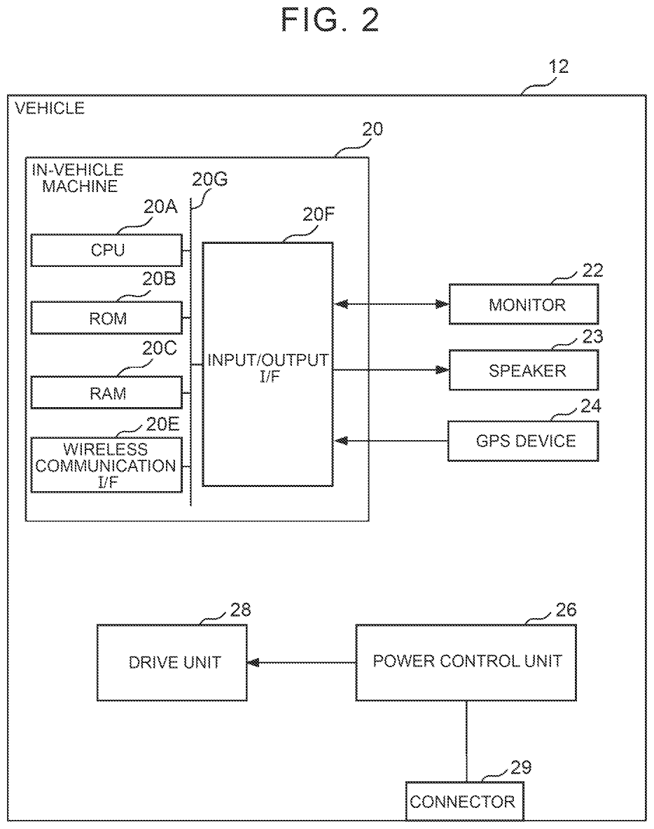

The vehicle 12 of the present embodiment is an electric automobile that is driven by a battery. As shown in FIG. 2, the vehicle 12 according to the present embodiment is configured to include the in-vehicle machine 20, a monitor 22, a speaker 23, and a GPS device 24. Besides, the vehicle 12 is configured to include a power control unit 26, a drive unit 28, and a connector 29.

The in-vehicle machine 20 is configured to include a central processing unit (CPU) 20A, a read-only memory (ROM) 20B, a random access memory (RAM) 20C, a wireless communication I/F 20E, and an input/output I/F 20F. The CPU 20A, the ROM 20B, the RAM 20C, the wireless communication I/F 20E, and the input/output I/F 20F are connected to one another in a mutually communicable manner, via an internal bus 20G.

The CPU 20A is a central processing unit, and executes various programs and controls respective components. That is, the CPU 20A retrieves a program from the ROM 20B, and executes the program with the RAM 20C serving as a working area.

Various programs and various data are stored in the ROM 20B. A control program for controlling the in-vehicle machine 20 is stored in the ROM 20B of the present embodiment.

The RAM 20C serves as a working area in which programs or data are temporarily stored.

The wireless communication I/F 20E is a wireless communication module for communicating with the control devices 40 and the administrative server 30. For example, communication standards such as 5G, LTE, and Wi-Fi (registered trademark) are used for this wireless communication module. The wireless communication I/F 20E is connected to the network N.

The input/output I/F 20F is an interface for communicating with the monitor 22, the speaker 23, and the GPS device 24 with which the vehicle 12 is loaded. Incidentally, the monitor 22, the speaker 23, and the GPS device 24 may be directly connected to the internal bus 20G.

The monitor 22 is a liquid-crystal monitor that is provided in an instrumental panel, a dashboard or the like of the vehicle 12 to display various pieces of information. Besides, the monitor 22 of the present embodiment has a touch panel. For example, a piece of information on destinations of the self-propelled pallets 14 may be input through the operation of the touch panel by a driver of the vehicle 12.

The speaker 23 is a device that is provided in an instrument panel, a center console, a front pillar, a dashboard or the like to output sound. Incidentally, the speaker 23 may be provided integrally with the monitor 22.

The GPS device 24 is a device that measures a current position of the vehicle 12. The GPS device 24 includes an antenna (not shown) that receives a signal from a GPS satellite. Incidentally, the GPS device 24 may be connected to the in-vehicle machine 20 via a car navigation system (not shown).

The power control unit 26 is a device that electrically controls the drive unit 28 that will be described later, and includes at least a step-up converter and an inverter. The power control unit 26 is supplied with electric power from a vehicle battery 44B that will be described later, via the connector 29.

The drive unit 28 is a device that drives driving wheels 13 of the vehicle 12, and includes at least a running motor and a transaxle. Upon being supplied with electric power for driving from the power control unit 26, the drive unit 28 drives a motor to rotate the driving wheels 13.

The connector 29 is a terminal to be connected to the vehicle battery 44B that will be described later. The connector 29 is provided inside a luggage compartment 12A of the vehicle 12, and is provided in such a manner as to be connectable to connectors 49B provided on the self-propelled pallets 14 respectively.

### Self-Propelled Pallets

In each of the self-propelled pallets 14, the control device 40 transmits charging capacities of a pallet battery 44A and the vehicle battery 44B and a current position of the self-propelled pallet 14 to the administrative server 30 at a predetermined timing. Besides, upon receiving a command to move the self-propelled pallet 14 from the administrative server 30, the control device 40 moves the self-propelled pallet 14 in accordance with the command.

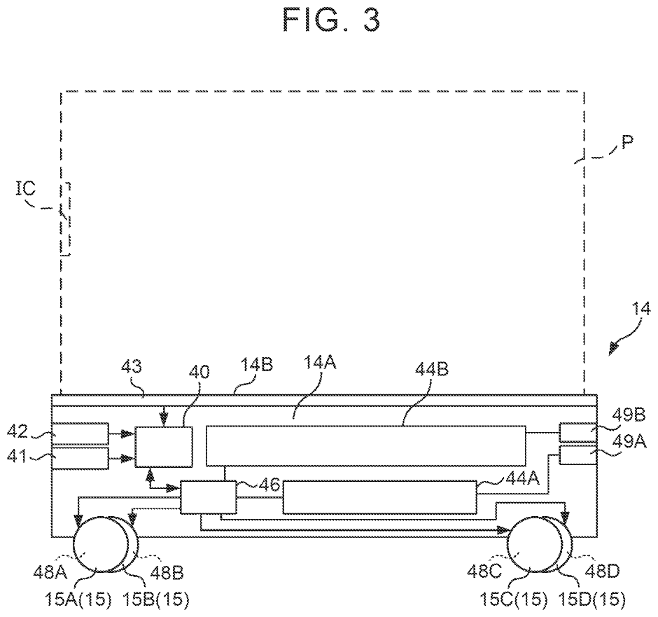

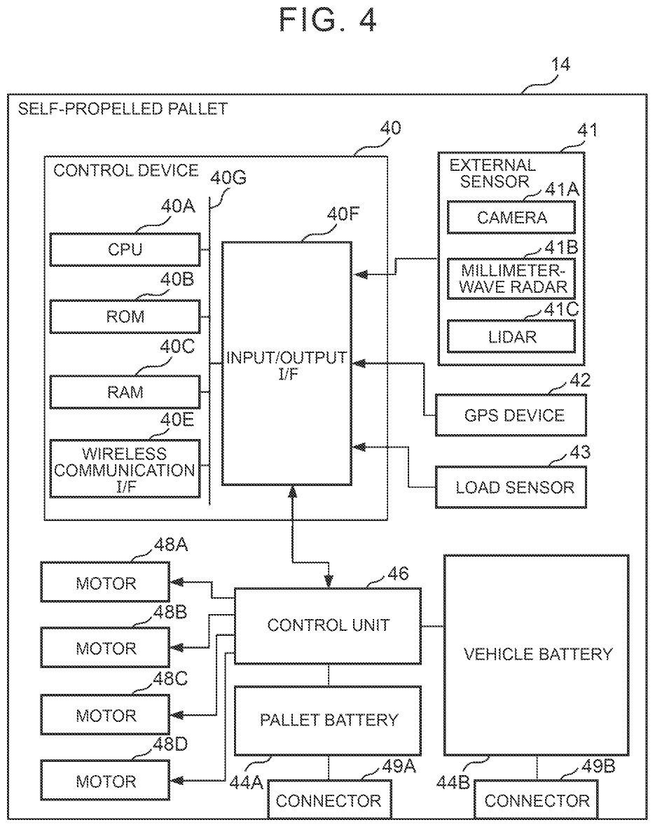

As shown in FIG. 3, the self-propelled pallet 14 according to the present embodiment is configured to include a rectangular parallelepiped main body portion 14A that is smaller in height than in width and length, a loading portion 14B having an upper surface loaded with a piece of luggage P, and wheels 15 as running wheels provided at a lower portion of the self-propelled pallet 14. The wheels 15 include wheels 15A to 15D provided close to corner portions of the main body portion 14A respectively. Besides, as shown in FIG. 4, the self-propelled pallet 14 is configured to include the control device 40, an external sensor 41, a GPS device 42, and a load sensor 43. Besides, the self-propelled pallet 14 is configured to include the pallet battery 44A, the vehicle battery 44B, a control unit 46, motors 48A to 48D, and connectors 49A and 49B.

The control device 40 is configured to include a CPU 40A, a ROM 40B, a RAM 40C, a wireless communication I/F 40E, and an input/output I/F 40F. The CPU 40A, the ROM 40B, the RAM 40C, the wireless communication I/F 40E, and the input/output I/F 40F are connected to one another in such a manner as to be able to communicate with one another via an internal bus 40G. The CPU 40A, the ROM 40B, the RAM 40C, the wireless communication I/F 40E, and the input/output I/F 40F are identical in structure to the CPU 20A, the ROM 20B, the RAM 20C, the wireless communication I/F 20E, and the input/output I/F 20F of the in-vehicle machine 20 respectively.

Incidentally, the wireless communication I/F 40E of the present embodiment is connected to the network N, and is connected to the in-vehicle machine 20 and the administrative server 30 via the network N (see FIG. 1).

Besides, the external sensor 41, the GPS device 42, the load sensor 43, and the control unit 46 are connected to the input/output I/F 40F. Incidentally, the external sensor 41, the GPS device 42, the load sensor 43, and the control unit 46 may be directly connected to the internal bus 40G.

The external sensor 41 as an environment sensor is constituted of a group of sensors for collecting environmental information around the self-propelled pallet 14. The external sensor 41 includes at least a camera 41A that images an area around the self-propelled pallet 14. Besides, the external sensor 41 includes a millimeter-wave radar 41B that transmits probing waves to a predetermined range and that receives reflected waves, and a laser imaging detection and ranging (lidar) 41C that scans the predetermined range.

The GPS device 42 is a device that measures a current position of the self-propelled pallet 14. The GPS device 42 includes an antenna (not shown) that receives a signal from a GPS satellite.

The load sensor 43 as a measurement unit is a sensor that is provided at a lower portion of the loading portion 14B to measure a weight of the piece of luggage P placed on the loading portion 14B.

The pallet battery 44A is a battery for motive power of the self-propelled pallet 14, and is mounted in the main body portion 14A. The pallet battery 44A is electrically connected to the control unit 46 and the connector 49A.

The vehicle battery 44B is a battery for motive power of the vehicle 12, and is mounted in the main body portion 14A. The vehicle battery 44B is electrically connected to the control unit 46 and the connector 49B. Incidentally, the vehicle battery 44B is not absolutely required to be connected to the control unit 46, but is desired to be connected to the control unit 46 or the control device 40 to grasp the charging capacity of the vehicle battery 44B.

The control unit 46 is a device that individually controls the motor 48A and the motor 48B that will be described later. The control unit 46 accepts a control signal from the control device 40, and is supplied with electric power from the pallet battery 44A. Besides, the control unit 46 measures charging capacities of the pallet battery 44A and the vehicle battery 44B.

The motors 48A to 48D as drive units are in-wheel motors that drive the wheels 15A to 15D provided at the lower portion of the self-propelled pallet 14 respectively. The motor 48A is provided on the wheel 15A, the motor 48B is provided on the wheel 15B, the motor 48C is provided on the wheel 15C, and the motor 48D is provided on the wheel 15D. Upon being supplied with electric power for driving from the control unit 46, the motors 48A to 48D drive the corresponding wheels 15 respectively. In the present embodiment, the traveling direction of the self-propelled pallet 14 is changed by individually controlling the wheels 15A to 15D, but the applicable embodiment is not limited thereto. However, the traveling direction of the self-propelled pallet 14 may be controlled by configuring at least two of the wheels 15 in a turnable manner.

The connector 49A is a terminal that is provided at a lateral portion of the main body portion 14A to be connected to an external electric power supply in charging the pallet battery 44A.

The connector 49B is a terminal that is provided at the lateral portion of the main body portion 14A to be connected to an external electric power supply in charging the vehicle battery 44B and to be connected to the connector 29 of the vehicle 12 in supplying electric power of the vehicle battery 44B to the vehicle 12.

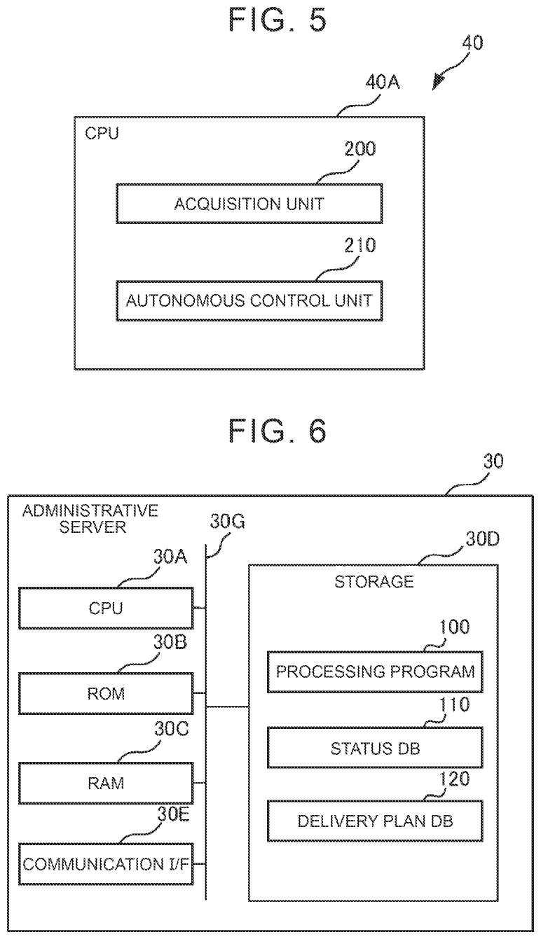

As shown in FIG. 5, the control device 40 of the present embodiment functions as an acquisition unit 200 and an autonomous control unit 210 through the execution of a control program stored in the ROM 40B by the CPU 40A.

The acquisition unit 200 acquires environmental information collected by the external sensor 41, more specifically, image information imaged by the camera 41A, information detected by the millimeter-wave radar 41B, and information scanned by the lidar 41C. Besides, the acquisition unit 200 acquires positional information on the self-propelled pallet 14 from the GPS device 42, and acquires information on the weight of the piece of luggage P from the load sensor 43. Furthermore, the acquisition unit 200 can acquire the charging capacities of the pallet battery 44A and the vehicle battery 44B from the control unit 46.

The autonomous control unit 210 has the function of causing the self-propelled pallet 14 to run autonomously by controlling the control unit 46, based on the environmental information acquired from the external sensor 41. The autonomous control unit 210 of the present embodiment drives the motors 48A to 48D based on a command received via the wireless communication I/F 40E, and causes the self-propelled pallet 14 to run to a spot designated by the command.

### Administrative Server

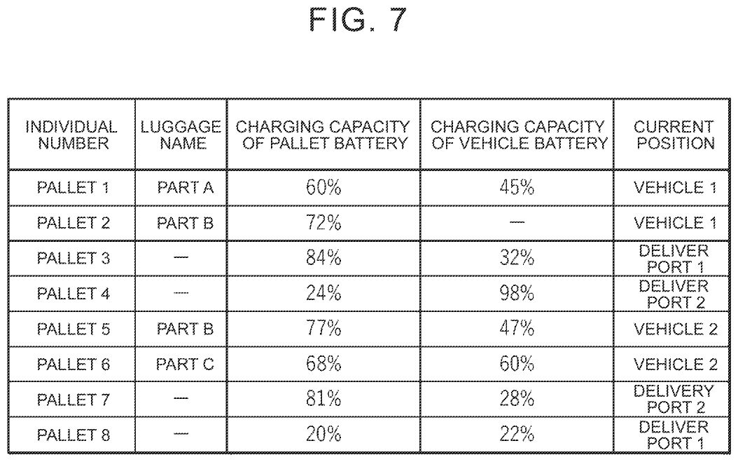

As shown in FIG. 6, the administrative server 30 as a command unit is configured to include a CPU 30A, a ROM 30B, a RAM 30C, a storage 30D, and a communication I/F 30E. The CPU 30A, the ROM 30B, the RAM 30C, the storage 30D, and the communication I/F 30E are connected to one another in such a manner as to be able to communicate with one another, via an internal bus 30G. The CPU 30A, the ROM 30B, the RAM 30C, and the communication I/F 30E are identical in function to the CPU 20A, the ROM 20B, the RAM 20C, and the wireless communication I/F 20E of the in-vehicle machine 20 respectively. Incidentally, the communication I/F 30E may establish communication in a wired manner.

The storage 30D as a storage unit is constituted by a hard disk drive (HDD) or a solid state drive (SSD). Various programs and various data are stored in the storage 30D.

The CPU 30A retrieves the program from the storage 30D, and executes the program with the RAM 30C serving as a working area.

A processing program 100, a status database (DB) 110, and a delivery plan DB 120 are stored in the storage 30D of the present embodiment.

The processing program 100 as a transportation program is a program for realizing the respective functions of the administrative server 30.

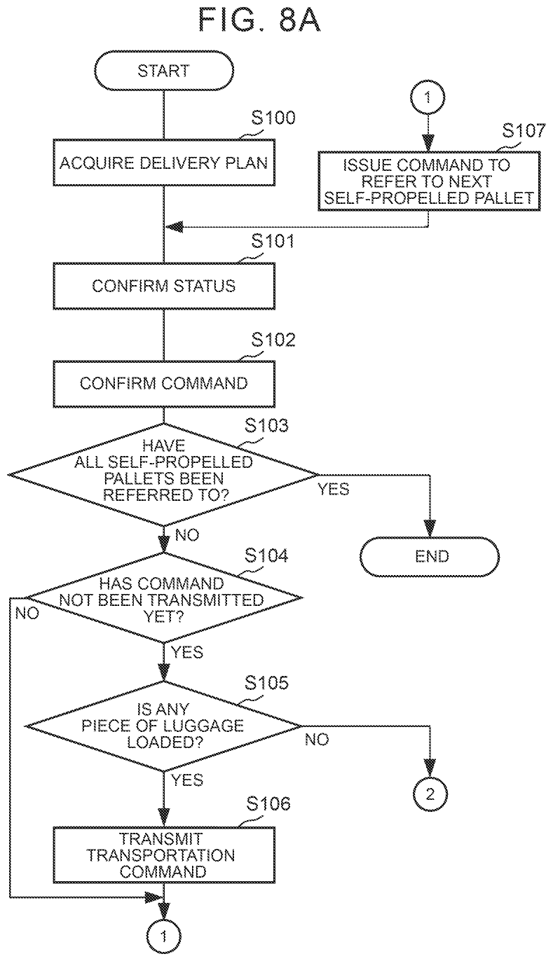

The status DB 110 is a database that collectively includes states of the self-propelled pallets 14. As shown in FIG. 7, for example, individual numbers of the self-propelled pallets 14, luggage names of the pieces of luggage P with which the self-propelled pallets 14 are loaded, the charging capacities of the pallet batteries 44A, the charging capacities of the vehicle batteries 44B, and the current positions of the self-propelled pallets 14 are stored in the status DB 110. The status DB 110 is generated based on the charging capacities of the pallet batteries 44A and the vehicle batteries 44B received from the respective self-propelled pallets 14 and the current positions of the self-propelled pallets 14. The information on the pieces of luggage P may be acquired from the self-propelled pallets 14 or the delivery plan DB that will be described later. Incidentally, the information on each of the self-propelled pallets 14 may be updated at intervals of a predetermined time, or as needed.

In the example of FIG. 7, the status DB 110 stores the states of the self-propelled pallets 14 of eight pallets 1 to 8. Each of the self-propelled pallets 14 is loaded with one of a part A, a part B, and a part C as the piece of luggage P, or with nothing (indicated by “-” in FIG. 7). The charging capacities of the pallet batteries 44A and the vehicle batteries 44B are stored as percentage ratios to the capacity at the time of full charge. Incidentally, a case where no vehicle battery 44B is mounted is indicated by “-” in FIG. 7. In FIG. 7, the current positions are indicated as spot names, but may be indicated as longitudes and latitudes or predetermined coordinates respectively.

The delivery plan DB 120 is a database that collectively includes a delivery plan of the pieces of luggage P that are transported by the vehicle 12 and the self-propelled pallets 14. At least information on the pieces of luggage P with which the self-propelled pallets 14 are loaded and places of acceptance of the self-propelled pallets 14 are stored in the delivery plan DB 120. The delivery plan stored in the delivery plan DB 120 may be generated in the administrative server 30, or may be acquired from, for example, an external server that administrates the flow of goods.

### Flow of Control

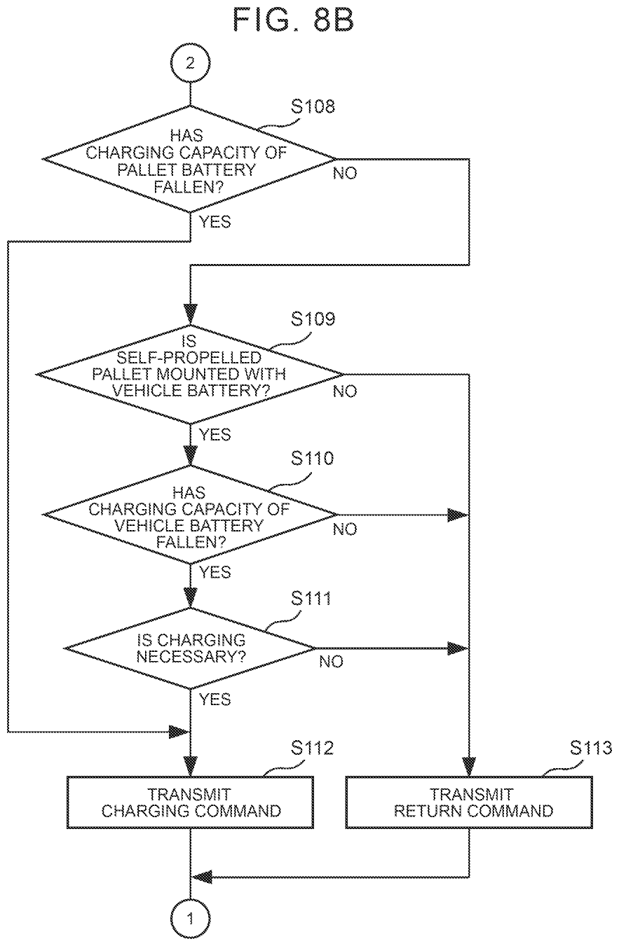

The flow of a guidance process that is performed in the administrative server 30 of the present embodiment, which is a transportation method of the present disclosure, will be described through the use of flowcharts of FIGS. 8A and 8B. This process is realized through the execution of the processing program 100 by the CPU 30A.

In step S100 of FIG. 8A, the CPU 30A of the administrative server 30 acquires a delivery plan. In concrete terms, the CPU 30A refers to the delivery plan DB 120, and acquires delivery plans of the vehicle 12 and the respective self-propelled pallets 14.

In step S101, the status of one of the self-propelled pallets 14 is confirmed. That is, the CPU 30A refers to the status DB 110 stored in the storage 30D.

In step S102, the CPU 30A confirms a command. That is, the CPU 30A confirms whether or not any one of a transportation command, a charging command, and a return command has been transmitted to the self-propelled pallets 14.

In step S103, the CPU 30A determines whether or not all the self-propelled pallets 14 in the status DB 110 have been referred to. If it is determined that all the self-propelled pallets 14 have been referred to (YES in step S103), the CPU 30A ends the guidance process. On the other hand, if it is determined that not all the self-propelled pallets 14 have been referred to (NO in step S103), the CPU 30A proceeds to step S104.

In step S104, the CPU 30A determines whether or not no command has been transmitted. If it is determined that no command has been transmitted (YES in step S104), the CPU 30A proceeds to step S105. On the other hand, if it is determined that at least one command has been transmitted (NO in step S104), the CPU 30A proceeds to step S107.

In step S105, the CPU 30A determines whether or not any one of the self-propelled pallets 14 is loaded with the piece of luggage P. If it is determined that one of the self-propelled pallets 14 is loaded with the piece of luggage P (YES in step S105), the CPU 30A proceeds to step S106. On the other hand, if it is determined that none of the self-propelled pallets 14 is loaded with the piece of luggage P (NO in step S105), the CPU 30A proceeds to step S108 of FIG. 8B.

In step S106, the CPU 30A transmits a transportation command. That is, the CPU 30A commands the self-propelled pallet 14 to run to a place of reception of the piece of luggage P. Thus, the self-propelled pallet 14 that has received the transportation command transports the piece of luggage P with which the self-propelled pallet 14 is loaded to the place of reception.

In step S107, the CPU 30A commands reference to the next self-propelled pallet 14. The CPU 30A then returns to step S101.

In step S108 of FIG. 8B, the CPU 30A determines whether or not the charging capacity of the pallet battery 44A has fallen. For example, the CPU 30A determines that the charging capacity of the pallet battery 44A has fallen when the charging capacity becomes lower than 25%. If it is determined that the charging capacity of the pallet battery 44A has fallen (YES in step S108), the CPU 30A proceeds to step S112. On the other hand, if it is determined that the charging capacity of the pallet battery 44A has not fallen (NO in step S108), the CPU 30A proceeds to step S109.

In step S109, the CPU 30A determines whether or not the self-propelled pallet 14 is mounted with the vehicle battery 44B. If it is determined that the self-propelled pallet 14 is mounted with the vehicle battery 44B (YES in step S109), the CPU 30A proceeds to step S110. On the other hand, if it is determined that the self-propelled pallet 14 is not mounted with the vehicle battery 44B (NO in step S109), the CPU 30A proceeds to step S113.

In step S110, the CPU 30A determines whether or not the charging capacity of the vehicle battery 44B has fallen. For example, the CPU 30A determines that the charging capacity of the vehicle battery 44B has fallen when the charging capacity becomes lower than 30%. If it is determined that the charging capacity of the vehicle battery 44B has fallen (YES in step S110), the CPU 30A proceeds to step S111. On the other hand, if it is determined that the charging capacity of the vehicle battery 44B has not fallen (NO in step S110), the CPU 30A proceeds to step S113.

In step S111, the CPU 30A determines whether or not the vehicle battery 44B needs to be charged. For example, in the case where there are some self-propelled pallets 14 having the vehicle batteries 44B already charged, the charging of the vehicle batteries 44B in a predetermined number or more of self-propelled pallets 14 can be omitted, so as to reduce the number of self-propelled pallets 14 that cannot move because of charging. If it is determined that the vehicle battery 44B needs to be charged (YES in step S111), the CPU 30A proceeds to step S112. On the other hand, if it is determined that the vehicle battery 44B does not need to be charged (NO in step S111), the CPU 30A proceeds to step S113.

In step S112, the CPU 30A transmits a charging command. That is, the CPU 30A commands the self-propelled pallet 14 to a place of charging. Thus, the self-propelled pallet 14 that has received the charging command runs to the place of charging, and the pallet battery 44A or the vehicle battery 44B is charged through connection of the connectors 49A and 49B to a charger installed at the place of charging. Incidentally, even in the case where the charging capacity of only one of the pallet battery 44A and the vehicle battery 44B has fallen, both the pallet battery 44A and the vehicle battery 44B may be charged. Upon the completion of transmission of the charging command, the CPU 30A returns to step S107 of FIG. 8A.

In step S113, the CPU 30A transmits a return command. That is, the CPU 30A commands the self-propelled pallet 14 to run to the vehicle 12. Thus, the self-propelled pallet 14 that has received the return command runs to the luggage compartment 12A of the vehicle 12. Incidentally, the electric power of the vehicle battery 44B is supplied to the power control unit 26 through connection of the connector 49B to the connector 29 provided in the luggage compartment 12A. Upon the completion of transmission of the return command, the CPU 30A returns to step S107 of FIG. 8A.

Each of the self-propelled pallets 14 referred to in the status DB 110 of FIG. 7 moves as follows, through the performance of the guidance process as described above. First of all, the self-propelled pallet 14 loaded with the piece of luggage P transports the piece of luggage P to the place of reception in accordance with a transportation plan. That is, the pallet 1 transports the part A from a vehicle 1 to the place of reception, the pallet 2 transports the part B from the vehicle 1 to the place of reception, the pallet 5 transports the part B from a vehicle 2 to the place of reception, and the pallet 6 transports the part C from the vehicle 2 to the place of reception.

On the other hand, the destination of the self-propelled pallet 14 loaded with no luggage P changes depending on the charging capacities of the pallet battery 44A and the vehicle battery 44B. That is, the charging capacities of the pallet battery 44A and the vehicle battery 44B of the pallet 3 have not fallen, and the pallet 3 moves from a delivery port 1 as the place of reception of the piece of luggage P toward the vehicle 12. Besides, the charging capacity of the pallet battery 44A of the pallet 4 has fallen to or below 25%, so the pallet 4 moves from a delivery port 2 as the place of reception of the piece of luggage P toward the place of charging. Besides, the charging capacity of the vehicle battery 44B of the pallet 7 has fallen to or below 30%, the pallet 7 moves from the delivery port 2 as the place of reception of the piece of luggage P toward the place of charging. Furthermore, the charging capacity of the pallet battery 44A of the pallet 8 has fallen to or below 25% and the charging capacity of the vehicle battery 44B of the pallet 8 has fallen to or below 30%, so the pallet 8 moves from the delivery port 1 as the place of reception of the piece of luggage P toward the place of charging.

### Summary of Embodiment

As described above, the transportation system 10 according to the present embodiment is equipped with the vehicle 12, the self-propelled pallets 14, and the administrative server 30 as the command unit. The self-propelled pallets 14 of the present embodiment are configured to be able to run on the ground and to be accommodated in the luggage compartment 12A of the vehicle 12. Besides, the administrative server 30 of the present embodiment commands the self-propelled pallet 14 loaded with the piece of luggage P to move from the place of arrival of the vehicle 12 to the place of reception of the piece of luggage P. Besides, after the piece of luggage P is unloaded at the place of reception, the administrative server 30 commands the self-propelled pallet 14 loaded with no luggage P to move to the vehicle 12, depending on the circumstances.

In consequence, with the transportation system 10 of the present embodiment, when the piece of luggage P is conveyed from the place of arrival of the vehicle 12 to the place of reception, the operation of reloading the piece of luggage P into another vehicle can be omitted. Thus, the loss of time for unloading luggage can be reduced.

Incidentally, the self-propelled pallet 14 from which the piece of luggage P has been unloaded at the place of reception may be loaded with another piece of luggage. That is, after the piece of luggage P is unloaded at the place of reception, the administrative server 30 can command the self-propelled pallet 14 loaded with this another piece of luggage to move to the vehicle 12. Thus, the vehicle 12 that has transported the piece of luggage P can be used to transport other pieces of luggage, so the efficiency in transporting the piece of luggage P and other pieces of luggage by the vehicle 12 can be enhanced.

Besides, the present embodiment is characterized in that the self-propelled pallets 14 run autonomously. Therefore, according to the present embodiment, there is no need to provide a tow vehicle that is needed to move pallets with no motive power source.

Besides, according to the present embodiment, through adoption of the self-propelled pallets 14 that are standardized or normalized in specifications such as size, the self-propelled pallets 14 can be used for different vehicles 12. For example, no trouble is caused even when another self-propelled pallet 14 is accommodated in a certain one of the vehicles 12, instead of waiting for the self-propelled pallet 14 that has transported the piece of luggage P from the vehicle 12 to the place of reception to return. Therefore, according to the present embodiment, the waiting time until the return of the self-propelled pallet 14 that has left the vehicle 12 to the vehicle 12 can be eliminated, and the efficiency in transporting the piece of luggage P can be further enhanced.

Furthermore, in the present embodiment, the vehicle 12 accommodating the self-propelled pallets 14 is an electric automobile that is driven by a battery. In the present embodiment, each of the self-propelled pallets 14 is mounted with the vehicle battery 44B for driving the vehicle 12. The vehicle battery 44B is replaced by replacing each of the self-propelled pallets 14 with another one. It should be noted herein that when the vehicle 12 is equipped with a vehicle battery, the vehicle 12 cannot move until the charging of the battery is completed. In contrast, according to the present embodiment, the self-propelled pallets 14 mounted with the vehicle batteries 44B charged in advance are accommodated in the vehicle 12, so the parking time resulting from charging can be made shorter than in the case where the vehicle 12 is equipped with a battery.

### Second Embodiment

In the first embodiment, the piece of luggage P is transported based on the delivery plan acquired in advance. In the second embodiment, however, the piece of luggage P is transported based on information on an identification tag attached to the piece of luggage P. The differences from the first embodiment will be described hereinafter. Incidentally, like components are denoted by like reference symbols, and the description thereof will be omitted.

In the transportation system 10 of the present embodiment, an identification code IC as an identification tag is displayed on the piece of luggage P (see FIG. 3). A camera 41A of the self-propelled pallet 14 is configured to be able to image the identification code IC of the piece of luggage P placed on the loading portion 14B as well as an area in front of the self-propelled pallet 14. The identification code IC of the present embodiment is a QR code (registered trademark).

In each of the control devices 40 of the present embodiment, when the acquisition unit 200 acquires image information on the identification code IC, the autonomous control unit 210 causes the self-propelled pallet 14 to run to the place of reception of the piece of luggage P that is a place of delivery, based on information on the place of delivery recorded in the identification code IC.

According to the present embodiment, the process of acquiring or generating the delivery plan in advance is unnecessary. Besides, according to the present embodiment, information on the place of reception is associated with the identification code IC. Thus, even when the reloading of the piece of luggage P or the like occurs in the vehicle 12, the process of redesignating the place of reception is unnecessary. Incidentally, the identification code as the identification tag may not necessarily be a QR code, but may be a bar code or any other type of two-dimensional code.

### Third Embodiment

The third embodiment is characterized in that the destination of transportation is changed in accordance with the weight of the piece of luggage P. The difference from the first embodiment will be described hereinafter. Incidentally, like components are denoted by like reference symbols, and the description thereof will be omitted.

In each of the control devices 40 of the present embodiment, when the acquisition unit 200 acquires information on the weight of the piece of luggage P from the load sensor 43, the autonomous control unit 210 causes each of the self-propelled pallets 14 to run to one of a plurality of places of reception, based on the weight measured by the load sensor 43.

According to the present embodiment, in the case where there are a plurality of places of reception of the same piece of luggage P, the efficiency of transportation from the place of arrival of the vehicle 12 onward can be enhanced by selecting the place of reception, based on the weight measured by the load sensor 43.

### Remarks

In each of the foregoing embodiments, the administrative server 30 functions as the command unit that commands each of the self-propelled pallets 14 to move, but the applicable embodiment is not limited thereto. The in-vehicle machine 20 of the vehicle 12 may function as the command unit.

In each of the foregoing embodiments, the pallet battery 44A and the vehicle battery 44B are charged by a contact-type charger, but the applicable embodiment is not limited thereto. The pallet battery 44A and the vehicle battery 44B may be charged by a non-contact-type charger.

In the third embodiment, the destination of transportation is changed in accordance with the weight of the piece of luggage P, but the applicable embodiment is not limited thereto. The destination of transportation may be changed in accordance with the charging capacity of the pallet battery 44A or the charging capacity of the vehicle battery 44B. For example, in the case where the charging capacity of the pallet battery 44A is low, the charging time of the pallet battery 44A can be ensured by designating a destination of transportation located at a short reciprocal distance from the vehicle 12. The same holds true for the vehicle battery 44B.

Incidentally, in each of the foregoing embodiments, various processors other than the CPU may perform the various processes performed through retrieval of the pieces of software (the programs) by the CPU 20A, 30A, or 40A. In this case, programmable logic devices (PLD) that can be changed in circuit configuration after being manufactured, such as a field-programmable gate array (FPGA), dedicated electric circuits as processors having a circuit configuration designed exclusively for the performance of a specific process, such as an application specific integrated circuit (ASIC), and the like are exemplified as the processors. Besides, the aforementioned acceptance process may be performed by one of these various processors, or a combination of two or more identical or different processors (e.g., a plurality of FPGA's, a combination of a CPU and an FPGA, or the like). Besides, in more concrete terms, the hardware-like structure of these various processors is an electric circuit as a combination of circuit elements such as semiconductor elements.

Besides, in each of the foregoing embodiments, the respective programs have been described as being stored (installed) in advance in a computer-readable, non-temporary recording medium. For example, the control program in the in-vehicle machine 20 is stored in advance in the ROM 20B, the control program in the control devices 40 is stored in advance in the ROM 40B, and the processing program 100 in the administrative server 30 is stored in advance in the storage 30D. However, the applicable embodiment is not limited to this example. The respective programs may be offered as those recorded in non-temporary recording media such as a compact disc read-only memory (CD-ROM), a digital versatile disc read-only memory (DVD-ROM), and a universal serial bus (USB). Besides, the programs may be designed to be downloaded from an external device via a network.

The processes in each of the foregoing embodiments may be performed not only by a single processor but also through cooperation of a plurality of processors. The flow of the processes described in each of the foregoing embodiments is also nothing more than an example. Unnecessary steps may be deleted, new steps may be added, or the processes may be permutated, within such a range as not to depart from the gist of the present disclosure.

What is claimed is:

1. A transportation system comprising:
at least one transporter that can move and that is loaded with a piece of luggage;
a vehicle that accommodates the at least one transporter; and
a command unit that commands the transporter loaded with the piece of luggage to move to a place of reception of the piece of luggage, and that commands the transporter loaded with another piece of luggage or the transporter loaded with no luggage to move to the vehicle after the piece of luggage is unloaded at the place of reception.

2. The transportation system according to claim 1, wherein
the transporter is equipped with an environment sensor that collects environmental information around the transporter, a drive unit to which a running wheel is connected, and an autonomous control unit that controls the drive unit based on the collected environmental information and that causes the transporter to autonomously run to the place of reception.

3. The transportation system according to claim 2, wherein
the environment sensor collects an identification tag attached to the piece of luggage with which the transporter is loaded, as identification information, and
the autonomous control unit causes the transporter to run to the place of reception of the piece of luggage to which the identification tag is attached, based on the collected identification information.

4. The transportation system according to claim 2, wherein
the transporter is equipped with a measurement unit that measures a weight of the piece of luggage with which the transporter is loaded, and
the autonomous control unit causes the transporter to run to the place of reception as one of a plurality of such places of reception, based on the weight measured by the measurement unit.

5. The transportation system according to claim 1, comprising:
a plurality of standardized transporters identical to the transporter.

6. The transportation system according to claim 1, wherein
the transporter is equipped with a battery for driving the vehicle, and
the command unit commands the transporter with the charged battery to move to the vehicle.

7. A transportation method in a transportation system equipped with at least one transporter that can move and that is loaded with a piece of luggage, and a vehicle that accommodates the at least one transporter, wherein
a computer performs a process of commanding the transporter loaded with the piece of luggage to move to a place of reception of the piece of luggage, and commanding the transporter loaded with another piece of luggage or the transporter loaded with no luggage to move to the vehicle after the piece of luggage is unloaded at the place of reception.

8. A transportation program that is executed in a transportation system equipped with at least one transporter that can move and that is loaded with a piece of luggage, and a vehicle that accommodates the at least one transporter, the transportation program being designed to cause a computer to perform a process of commanding the transporter loaded with the piece of luggage to move to a place of reception of the piece of luggage, and commanding the transporter loaded with another piece of luggage or the transporter loaded with no luggage to move to the vehicle after the piece of luggage is unloaded at the place of reception.
